(19) United States
(12) Patent Application Publication
(10) Pub. No.: US 2023/0149257 A1
(43) Pub. Date: May 18, 2023

(54) MASSAGE DEVICE FOR LEGREST OF VEHICLE SEAT

(71) Applicants: Hyundai Motor Company, Seoul (KR); Kia Corporation, Seoul (KR); Jahwa Electronics CO., LTD., Cheongju (KR); Hyundai Transys Inc., Seosan (KR)

(72) Inventors: Sang Hark Lee, Incheon (KR); Sang Do Park, Suwon (KR); Deok Soo Lim, Hwaseong (KR); Jung Sang You, Hwaseong (KR); Ho Suk Jung, Hwaseong (KR); Chan Ho Jung, Gunpo (KR); Sang Soo Lee, Hwaseong (KR); Hyun Gyu Sung, Cheongju (KR); Sang Gyu Byeon, Cheongju (KR); Hyun Seok Song, Hwaseong (KR); Beom Sun Kim, Hwaseong (KR)

(21) Appl. No.: 17/983,842

(22) Filed: Nov. 9, 2022

(30) Foreign Application Priority Data
Nov. 12, 2021 (KR) 10-2021-0155275

(51) Int. Cl. A61H 23/02

(52) U.S. Cl. CPC A61H 23/0254; A61H 2201/149; A61H 2201/0165; A61H 2201/501; A61H 2201/1669; A61H 2201/5005; A61H 2201/5025; A61H 2201/5071; A61H 2205/106

(57) ABSTRACT

Disclosed is a massage device for a legrest of a vehicle seat in which a massage module capable of massaging the calves of a passenger by striking the same is installed so as to massage the calves of the passenger, thereby improving blood flow to the calves and significantly reducing the fatigue of the passenger.

### CROSS-REFERENCE TO RELATED APPLICATION

This application claims under 35 U.S.C. §119(a) the benefit of Korean Patent Application No. 10-2021-0155275 filed on Nov. 12, 2021, the entire contents of which are incorporated herein by reference.

### TECHNICAL FIELD

Embodiments of the present disclosure relate to a massage device for a legrest of a vehicle seat. More particularly, it relates to a massage device for a legrest of a vehicle seat installed in the legrest of the seat so as to perform a massage on the legs of a passenger in a striking manner.

### DESCRIPTION OF RELATED ART

When a passenger sits in a vehicle seat for a long time, the passenger feels uncomfortable due to the continued feeling of pressure on a passenger’s body, which is in close contact with the seat, leading to stiffness in the passenger’s upper and lower body, muscle pain, and the like. In order to solve the above-described problems, a seat massage device capable of massaging the passenger’s body is installed in the seats of some luxury vehicles.

The seat massage device is mainly installed inside a seatback, which is in close contact with the passenger’s back and waist, and a seat cushion, which is in close contact with the passenger’s hips and thighs, among the plurality of seat components.

As an example of a seat massage device of the related art, a plurality of air cells may be installed in the seatback and seat cushion, thereby performing a massage by expanding and contracting the air cells.

As another example of the seat massage device of the related art, a cylinder that moves back and forth due to an operation of a motor may be installed in the seatback and seat cushion, thereby performing a massage using the striking force of the cylinder.

As described above, the seat massage device of the related art is mainly installed either in the seatback or in the seat cushion, or in both the seatback and the seat cushion forming the seat, so that the massage can be easily performed on the upper body including the passenger’s back and waist and the lower body including the passenger’s hips and thighs.

However, since the seat massage device of the related art is mainly installed either in the seatback or in the seat cushion, or in both the seatback and the seat cushion forming the seat, there is a problem in that the calves of the passenger cannot be massaged.

Accordingly, when the passenger sits in the vehicle seat for a long time, the passenger may feel uncomfortable because the flow of blood to the calves of the passenger is impeded, which may problematically increase the fatigue of the passenger.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the related art, and it is an object of the present disclosure to provide a massage device for a legrest of a vehicle seat in which a massage module capable of massaging the calves of a passenger by striking the same is installed so as to massage the calves of the passenger, thereby improving the flow of blood to the calves and significantly reducing the fatigue of the passenger.

In one embodiment, the present disclosure provides a massage device for a legrest of a vehicle seat, the massage device including a case mounted on a legrest frame of the seat, a motor provided in a type including a bidirectional rotary shaft and mounted inside the case, eccentric shafts respectively eccentrically connected to the bidirectional rotary shafts of the motor, a motion conversion device connected to each of the eccentric shafts to convert a rotational motion of the eccentric shaft into a linear reciprocating motion, a linear motion device connected to the motion conversion device to perform the linear reciprocating motion, and a striking body connected to the linear motion device to strike a calf portion of a passenger.

In some embodiments, the striking body is disposed in a pad surrounded by a covering of the legrest.

In a preferred embodiment, the case may include an upper case assembled to the legrest frame while surrounding an upper surface portion of the motor, and a lower case assembled to the upper case while surrounding a lower surface portion of the motor.

In another preferred embodiment, two or more ring-shaped rubber dampers may be in close contact with an inner surface of the case and an outer surface of the motor while being disposed therebetween.

In still another preferred embodiment, the upper case may be assembled to a pair of cross plates mounted on the legrest frame.

In yet another preferred embodiment, the upper case may have a groove part formed at opposite side portions thereof, the groove part securing a reciprocating motion space of the linear motion device.

In still yet another preferred embodiment, the motion conversion device may include a bearing including the eccentric shaft rotatably inserted thereinto, and a connecting rod provided in a ring-shaped structure including the bearing inserted thereinto and coupled thereto, the connecting rod including a hinge end formed at an upper portion thereof and hingedly coupled to the linear motion device.

In some embodiments, the bearing is a ball bearing.

In a further preferred embodiment, the eccentric shaft may include a body part, a coupling groove formed on an inner surface of the body part so that the rotary shaft of the motor is inserted thereinto and coupled thereto, and an eccentric protrusion formed to protrude from an outer surface of the body part while being eccentric with the rotary shaft of the motor and inserted into an inner ring of the bearing.

In another further preferred embodiment, the linear motion device may include a slide shaft having a lower end portion hingedly coupled to the hinge end of the connecting rod and an upper end portion connected to the striking body, a linear guide having a hollow structure including the slide shaft inserted thereinto to be linearly movable, and a guide-fixing block provided in a structure including a press-fitting hole including the linear guide fixedly press-fitted thereinto, and mounted on opposite side portions of the motor.

In still another further preferred embodiment, the upper end portion of the slide shaft and the striking body may be connected to each other by a link configured to adjust a distance between the striking bodies.

In yet another further preferred embodiment, the striking body may be provided in an elliptical plate shape or a spherical shape.

In still yet another further preferred embodiment, the massage device for the legrest may further include a controller configured to control a speed of the motor.

In some embodiments, the controller performs a control operation to drive the motor when a user turns on a switch.

In a still further preferred embodiment, the controller may perform a control operation to increase the speed of the motor as a vehicle speed increases, and to decrease the speed of the motor as the vehicle speed decreases, based on a signal of a vehicle speed sensor.

In a yet still further preferred embodiment, the controller may perform a control operation to adjust the speed of the motor to a specific RPM for a driver warning in response to a warning signal received from a lane departure warning system.

As discussed, the method and system suitably include use of a controller or processer.

In another embodiment, vehicles are provided that comprise an apparatus as disclosed herein.

Other embodiments and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is an exploded perspective view showing a legrest massage device according to the present disclosure;

FIG. 2 is an assembled perspective view showing the legrest massage device according to the present disclosure;

FIG. 3 is a front cross-sectional view showing the legrest massage device according to the present disclosure;

FIG. 4 is a perspective view showing a state in which the legrest massage device according to the present disclosure is mounted on a legrest frame;

FIG. 5 is a main part cross-sectional view showing a state in which the legrest massage device according to the present disclosure is installed in a legrest;

FIGS. 6 to 9 are side cross-sectional views showing an operation flow of the legrest massage device according to the present disclosure;

FIG. 10 is a perspective view showing another embodiment of a striking body of the legrest massage device according to the present disclosure; and

FIG. 11 is a control configuration diagram of the legrest massage device according to the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

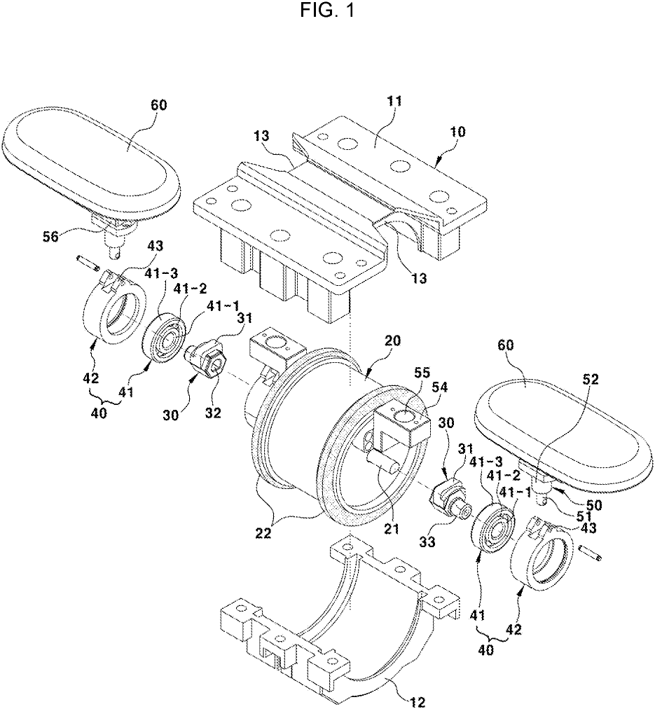

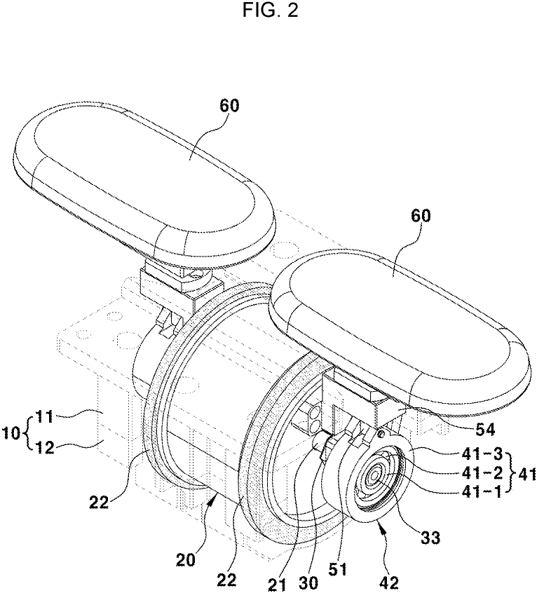

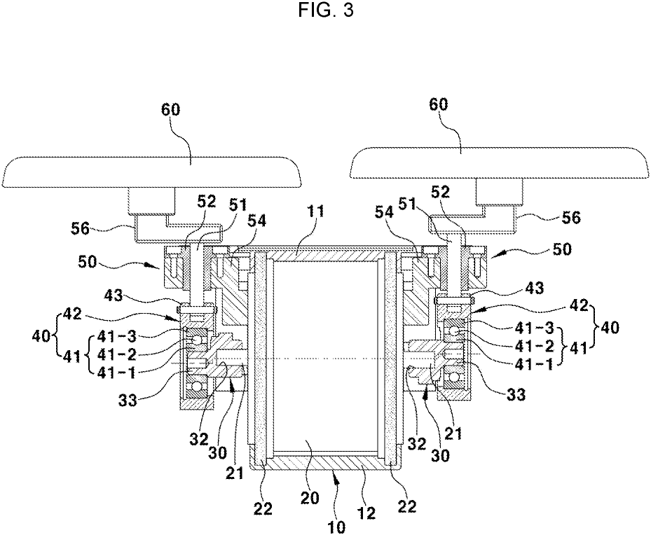

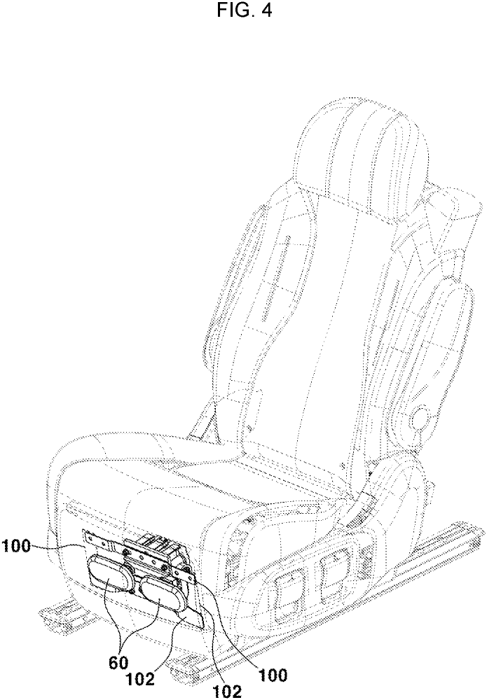

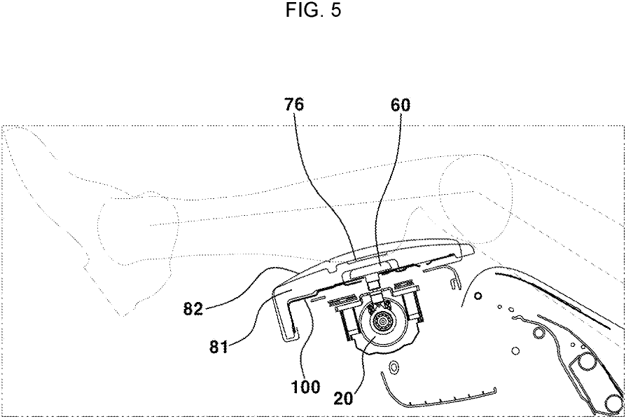

FIGS. 1 to 3 show a legrest massage device according to the present disclosure, FIGS. 4 and 5 show a state in which the legrest massage device according to the present disclosure is mounted on a legrest, and reference numeral 10 in each drawing represents a case.

The case 10 may be provided to fix a motor 20 while surrounding and protecting the same, and is mounted on a legrest frame 100.

To this end, the case 10 may be formed of an upper case 11 assembled to the legrest frame 100 by a bolt or the like while surrounding an upper surface portion of the motor 20, and a lower case 12 assembled to the upper case 11 by a bolt or the like while surrounding a lower surface portion of the motor 20.

Here, in order to prevent vibration and noise caused by driving of the motor 20 from being emitted to the outside through the case 10, two or more ring-shaped rubber dampers 22 may be in close contact with an inner surface of the case 10 and an outer surface of the motor 20 in the state of being disposed therebetween.

For example, after the rubber damper 22 is attached along an outer circumferential surface of the motor 20, as described above, the upper case 11 and the lower case 12, which are assembled with each other while surrounding the motor 20, may be in close contact with the rubber damper 22.

Accordingly, the vibration and noise caused by the driving of the motor 20 may be absorbed by the rubber damper 22, thereby making it possible to prevent the vibration and noise from being emitted to the outside, and, as such, the driving noise of the massage device can be reduced.

Preferably, as shown in FIG. 4, a pair of cross plates 102 may be mounted on the legrest frame 100 to increase the rigidity of the assembled massage device and to facilitate assembly of the massage device.

Accordingly, a rear space of the cross plate 102 may be secured as a packaging space for the massage device, and the upper case 11 of the case 10 may be easily mounted on the cross plate 102 using bolts or the like.

Preferably, in the configuration of the case 10, concavely cut groove parts 13 may be further formed at opposite side portions of the upper case 11 so as to secure a space for linear reciprocating motion of a slide shaft 51 of a linear motion device 50, as will be described later.

Meanwhile, the motor 20 mounted inside the case 10 may be of a type including a bidirectional rotary shaft 21, an eccentric shaft 30 is eccentrically connected to each rotary shaft 21, and the eccentric shaft 30 is connected to a motion conversion device 40 that converts the rotational motion of the eccentric shaft 30 into the linear reciprocating motion.

To this end, the motion conversion device 40 may be formed of a bearing 41 into which the eccentric shaft 30 is rotatably inserted, and a connecting rod 42 provided in a ring-shaped structure so that the bearing 41 is inserted thereinto and coupled thereto.

In this case, the bearing 41 may be implemented as a ball bearing including an inner ring 41-1 into and to which the eccentric shaft 30 is inserted and coupled, an outer ring 41-3 inserted into and coupled to an inner diameter portion of the connecting rod 42, and a ball 41-2 positioned between the inner ring 41-1 and the outer ring 41-3.

In addition, a hinge end 43 hingedly coupled to the slide shaft 51 of the linear motion device 50 may be formed at an upper portion of the connecting rod 42.

Meanwhile, the eccentric shaft 30 may be formed of a body part 31, a coupling groove 32 formed on an inner surface of the body part 31 so that the rotary shaft 21 of the motor 20 is inserted thereinto and coupled thereto, and an eccentric protrusion 33 formed to protrude from an outer surface of the body part 31 while being eccentric with the rotary shaft 21 of the motor 20 and inserted into and coupled to the inner ring 41-1 of the bearing 41.

Therefore, when the rotary shaft 21 rotates according to the driving of the motor 20, the body part 31 to which the rotary shaft 21 is coupled rotates therewith, and, simultaneously, the eccentric protrusion 33 formed on the outer surface of the body part 31 may rotate eccentrically with respect to the rotary shaft 21.

Further, when the eccentric protrusion 33 rotates eccentrically with respect to the rotary shaft 21, the inner ring 41-1 of the bearing 41, into and to which the eccentric protrusion 33 is inserted and coupled, may rotate together with the eccentric protrusion 33.

In this case, while the inner ring 41-1 of the bearing 41 rotates together with the eccentric protrusion 33 due to rolling contact motion with the ball 41-2, the outer ring 41-3 may not rotate but move around the inner ring 41-1 so as to form a revolving trajectory therearound, and, simultaneously, the connecting rod 42, which is in contact with the outer ring 41-3 of the bearing 41, may also move together with the outer ring 41-3 around the inner ring 41-1 so as to form the revolving trajectory therearound.

Particularly, since the connecting rod 42 is hingedly connected to the slide shaft 51 of the linear motion device 50 by the hinge end 43, the connecting rod 42 may cause the slide shaft 51 to perform the linear reciprocating motion when the connecting rod 42 moves together with the outer ring 41-3 around the inner ring 41-1 so as to form the revolving trajectory therearound.

As described above, the bearing 41 and the connecting rod 42 of the motion conversion device 40 may easily convert the rotational motion of the eccentric shaft 30 into the linear reciprocating motion.

Meanwhile, the linear motion device 50 may be formed to include: the slide shaft 51, a lower end portion of which is hingedly coupled to the hinge end 43 of the connecting rod 42, and an upper end portion of which is connected to a striking body 60 for substantially performing a massage; a linear guide 52 including a hollow structure provided to guide the linear motion of the slide shaft 51 and configured to allow the slide shaft 51 to be inserted thereinto to be linearly movable; and a guide-fixing block 54 provided in a structure including a press-fitting hole 55 into which the linear guide 52 is fixedly press-fitted and mounted on opposite side portions of the motor 20.

Accordingly, in the state in which the linear guide 52 is press-fitted into the press-fitting hole 55 of the guide-fixing block 54, the slide shaft 51 may stably perform the linear reciprocating motion along the inside of the linear guide 52.

Here, each of a pair of the striking bodies 60 may be disposed on the left and right sides, and a space between the striking bodies 60 respectively disposed thereon may be adjusted according to the specifications for the legrest.

To this end, an upper end portion of the slide shaft 51 and each striking body 60 may be connected to each other by a link 56 having a predetermined length elongated in the left and right directions.

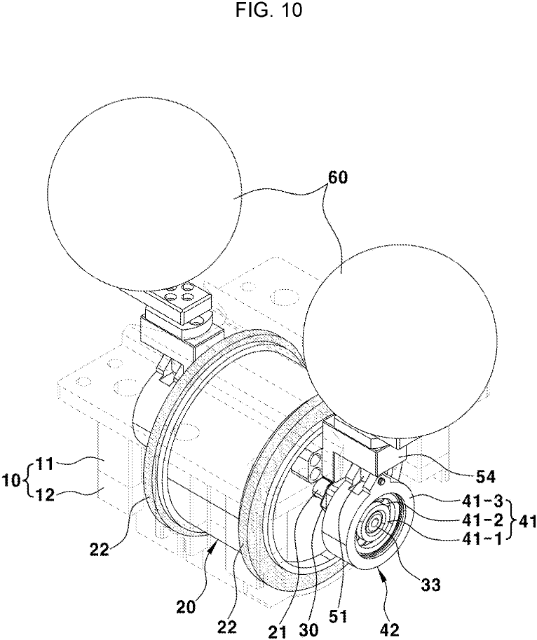

Preferably, the striking body 60 may be connected to the linear motion device 50 to strike and massage the calves of a passenger, and may be provided in an elliptical plate shape as shown in FIGS. 1 to 3 or may be provided in a spherical shape as shown in FIG. 10.

Substantially, as shown in FIG. 5, the striking body 60 may be disposed in a pad 81 surrounded by a covering 80 of the legrest, and, as such, the striking force of the striking body 60 for performing the massage may be transmitted to the calves of the passenger through the pad 81 and the covering 80.

Here, an operation flow of the legrest massage device of the present disclosure having the above-described configuration will be described as follows.

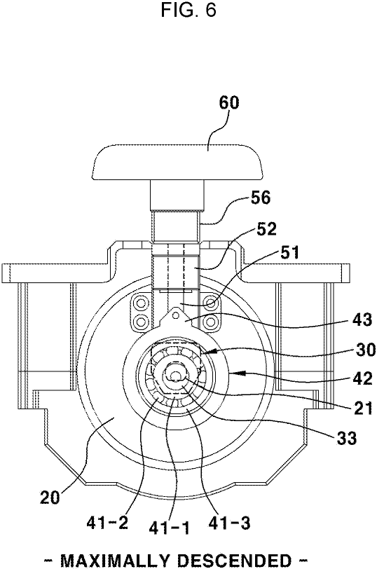

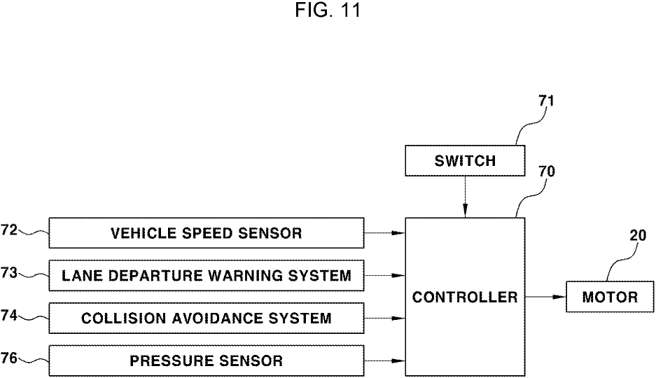

FIGS. 6 to 9 are side cross-sectional views showing the operation flow of the legrest massage device according to the present disclosure, and FIG. 11 is a control configuration diagram of the legrest massage device according to the present disclosure.

First, when a user turns on a switch 71 for driving the legrest massage device, a controller 70 may perform a control operation to drive the motor 20 for a massage operation at a predetermined speed.

Next, the bi-directional rotary shaft 21 may rotate according to the driving of the motor 20, and the eccentric shaft 30 also rotates.

More specifically, when the rotary shaft 21 rotates according to the driving of the motor 20, the body part 31 of the eccentric shaft 30, to which the rotary shaft 21 is coupled, may rotate together therewith, and, simultaneously, the eccentric protrusion 33 formed on the outer surface of the body part 31 may rotate eccentrically with respect to the rotary shaft 21.

In this case, when the eccentric protrusion 33 rotates eccentrically with respect to the rotary shaft 21, the inner ring 41-1 of the bearing 41, into and to which the eccentric protrusion 33 is inserted and coupled, may rotate together with the eccentric protrusion 33, and the outer ring 41-3 of the bearing 41 may not rotate, but move around the inner ring 41-1 so as to form the revolving trajectory therearound.

More specifically, when the eccentric protrusion 33 rotates eccentrically with respect to the rotary shaft 21, the inner ring 41-1 of the bearing 41, into and to which the eccentric protrusion 33 is inserted and coupled, may rotate together with the eccentric protrusion 33 due to the rolling contact motion with the ball 41-2, whereas the outer ring 41-3 of the bearing 41 may not rotate but move around the inner ring 41-1 so as to form the revolving trajectory therearound, and, simultaneously, the connecting rod 42, which is in contact with the outer ring 41-3 of the bearing 41, may also move together with the outer ring 41-3 around the inner ring 41-1 so as to form the revolving trajectory therearound.

In this case, since the connecting rod 42 is hingedly connected to the slide shaft 51 of the linear motion device 50 by the hinge end 43, the slide shaft 51 may perform the linear reciprocating motion when the connecting rod 42 moves together with the outer ring 41-3 around the inner ring 41-1 so as to form the revolving trajectory therearound.

For example, as shown in FIG. 6, when the eccentric protrusion 33 of the eccentric shaft 30 is positioned below the rotary shaft 21 of the motor 20, the outer ring 41-3 of the bearing 41 and the connecting rod 42 may be positioned at the lowermost position, such that the slide shaft 51 is in a state of being positioned at the rearmost position.

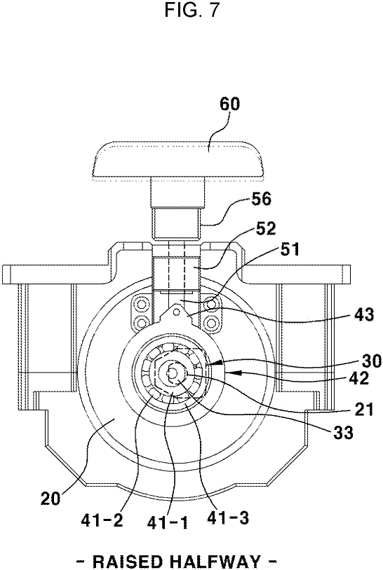

Further, as shown in FIG. 7, when the eccentric protrusion 33 of the eccentric shaft 30 rotates 90 degrees clockwise from the position of FIG. 6 and is positioned at the same height as the rotary shaft 21 of the motor 20, the connecting rod 42 and the outer ring 41-3 may move around the inner ring 41-1 so as to form the revolving trajectory therearound and push the slide shaft 51 in a forward direction, and, as such, the slide shaft 51 may be in a state of being moved forwards by about half of the maximum forward distance.

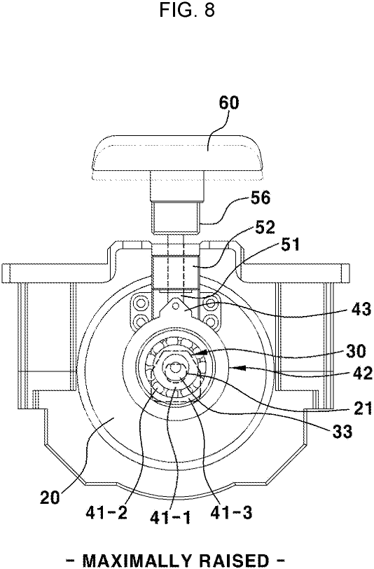

Further, as shown in FIG. 8, when the eccentric protrusion 33 of the eccentric shaft 30 further rotates 90 degrees clockwise from the position of FIG. 7 and is positioned above the rotary shaft 21 of the motor 20, the connecting rod 42 and the outer ring 41-3 may move around the inner ring 41-1 so as to form the revolving trajectory therearound and further push the slide shaft 51 in the forward direction, and, as such, the slide shaft 51 may be in a state of being moved forwards to the maximum.

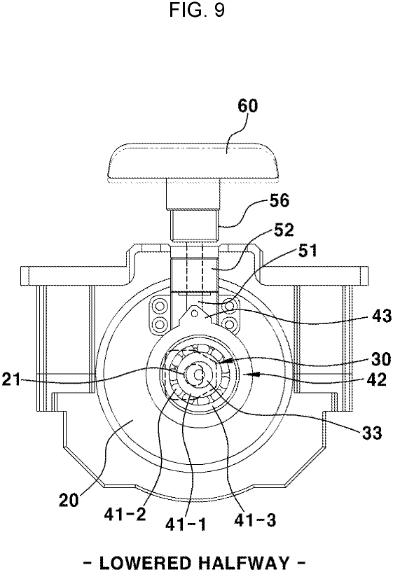

In addition, as shown in FIG. 9, when the eccentric protrusion 33 of the eccentric shaft 30 further rotates 90 degrees clockwise from the position of FIG. 8 and is positioned at the same height as the rotary shaft 21 of the motor 20, the connecting rod 42 and the outer ring 41-3 may move around the inner ring 41-1 so as to form the revolving trajectory therearound and pull the slide shaft 51 rearwards, and, as such, the slide shaft 51 may be in a state of being moved rearwards by about half of the maximum rearward distance.

Here, in the state in which the linear guide 52 is press-fitted into the press-fitting hole 55 of the guide fixing block 54 and is fixed therein, the slide shaft 51 may stably perform the linear reciprocating motion along the inside of the linear guide 52.

As described above, when the slide shaft 51 performs the linear reciprocating motion of repeated forward and rearward movements, the striking body 60, connected to the slide shaft 51, may also perform a massage to strike the calves of the passenger while repeatedly performing the linear reciprocating motion.

Preferably, one of the pair of striking bodies 60 may move forward due to the forward movement of the slide shaft 51, and, simultaneously, the other striking body 60 may move rearwards due to the rearward movement of the slide shaft 51, thereby performing a massage in which each striking body 60 alternately strikes the calves of the passenger.

In this manner, when a passenger or a driver feels fatigue in a leg portion due to long-term driving of a vehicle, the calves of the passenger may be massaged, thereby improving blood flow to the calves and significantly reducing the fatigue of the passenger. Further, the calves of the passenger may be massaged in a striking manner while the pair of striking bodies 60 sequentially ascend and descend, thereby improving massage performance compared to an air-cell or cylinder-type massage device of the related art.

Meanwhile, as shown in FIG. 11, the legrest massage device of the present disclosure may include the controller 70 for controlling the speed of the motor 20 to adjust the strength and pattern of the massage.

When the calves of the passenger are massaged by the linear reciprocating motion of the striking body 60 according to the driving of the motor 20, the strength of the massage sensed by the passenger may deteriorate due to road surface vibration and external noise when the vehicle is traveling at high speed.

To this end, the controller 70 may perform a control operation to increase the speed of the motor 20 as the vehicle speed increases and to decrease the speed of the motor 20 as the vehicle speed decreases, based on a signal from a vehicle speed sensor 72.

Accordingly, the controller 70 may perform the control operation to increase the speed of the motor 20 as the vehicle speed increases, thereby maintaining the perceived strength of the massage sensed by the passenger regardless of road surface vibration and external noise when the vehicle is traveling at high speed.

In addition, when receiving a warning signal from a lane departure warning system 73 or receiving a warning signal from a collision avoidance system 74 that adjusts the vehicle speed to avoid a collision depending on a distance between the vehicle and an obstacle, the controller 70 may perform a control operation to adjust the speed of the motor 20 to a specific RPM for a driver warning.

For example, when the massage is performed on the calves of the driver by the linear reciprocating motion of the striking body 60 according to the driving of the motor 20 while the vehicle is traveling, lane departure may occur due to carelessness of the driver.

Accordingly, upon receiving the warning signal from the lane departure warning system 73, the controller 70 may perform the control operation to adjust the speed of the motor 20 to the specific RPM for the driver warning so that the driver feels a warning vibration different from the massage, thereby allowing the driver to easily recognize a lane departure situation and to perform safe driving.

In addition, when receiving a body pressure detection signal of a pressure sensor 76 mounted on the legrest as shown in FIG. 5, the controller 70 may perform a control operation to adjust the speed of the motor 20 to a specific RPM depending on the magnitude of the body pressure, whereby the massage strength may be appropriately adjusted.

For example, the controller 70 may perform the control operation to adjust the motor 20 to a high RPM in order to increase the massage strength as the magnitude of the body pressure decreases, and may perform the control operation to adjust the motor 20 to a low RPM in order to reduce the massage strength as the magnitude of the body pressure increases.

As is apparent from the above description, the present disclosure provides the following effects.

First, a massage module capable of massaging the calves of a passenger by striking the same is installed in a legrest of a seat so as to massage the calves of the passenger, thereby improving blood flow to the calves and significantly reducing the fatigue of the passenger.

Second, a rubber damper is mounted between a case and a motor, thereby reducing driving noise of a massage device.

Third, the calves of the passenger are massaged in a striking manner while a pair of striking bodies sequentially ascend and descend, thereby improving massage performance compared to an air-cell or cylinder-type massage device of the related art.

Although the present disclosure has been described above in detail as one embodiment, the scope of the present disclosure is not limited thereto. It will be understood that various modifications and changes can be made by those skilled in the art without departing from the spirit and scope of the disclosure as defined by the appended claims.

What is claimed is:

1. A massage device for a legrest of a vehicle seat, the massage device comprising:
a case mounted on a legrest frame of the seat;
a motor provided in a type comprising a bidirectional rotary shaft and mounted inside the case;
eccentric shafts respectively eccentrically connected to the bidirectional rotary shafts of the motor;
a motion conversion device connected to each of the eccentric shafts to convert a rotational motion of the eccentric shaft into a linear reciprocating motion;
a linear motion device connected to the motion conversion device to perform the linear reciprocating motion; and
a striking body connected to the linear motion device to strike a calf portion of a passenger.

2. The massage device of claim 1, wherein the case comprises:
an upper case assembled to the legrest frame while surrounding an upper surface portion of the motor; and
a lower case assembled to the upper case while surrounding a lower surface portion of the motor.

3. The massage device of claim 1, wherein two or more ring-shaped rubber dampers are in close contact with an inner surface of the case and an outer surface of the motor while being disposed therebetween.

4. The massage device of claim 2, wherein the upper case is assembled to a pair of cross plates mounted on the legrest frame.

5. The massage device of claim 2, wherein the upper case has a groove part formed at opposite side portions thereof, the groove part securing a reciprocating motion space of the linear motion device.

6. The massage device of claim 1, wherein the motion conversion device comprises:
a bearing comprising the eccentric shaft rotatably inserted thereinto; and
a connecting rod provided in a ring-shaped structure comprising the bearing inserted thereinto and coupled thereto, the connecting rod comprising a hinge end formed at an upper portion thereof and hingedly coupled to the linear motion device.

7. The massage device of claim 6, wherein the eccentric shaft comprises:
a body part;
a coupling groove formed on an inner surface of the body part so that the rotary shaft of the motor is inserted thereinto and coupled thereto; and
an eccentric protrusion formed to protrude from an outer surface of the body part while being eccentric with the rotary shaft of the motor and inserted into an inner ring of the bearing.

8. The massage device of claim 6, wherein the linear motion device comprises:
a slide shaft having a lower end portion hingedly coupled to the hinge end of the connecting rod, and an upper end portion connected to the striking body;
a linear guide having a hollow structure comprising the slide shaft inserted thereinto to be linearly movable; and
a guide-fixing block provided in a structure comprising a press-fitting hole comprising the linear guide fixedly press-fitted thereinto, and mounted on opposite side portions of the motor.

9. The massage device of claim 8, wherein the upper end portion of the slide shaft and the striking body are connected to each other by a link configured to adjust a distance between the striking bodies.

10. The massage device of claim 1, wherein the striking body is provided in an elliptical plate shape or a spherical shape.

11. The massage device of claim 1, further comprising a controller configured to control a speed of the motor.

12. The massage device of claim 11, wherein the controller performs a control operation to increase the speed of the motor as a vehicle speed increases, and to decrease the speed of the motor as the vehicle speed decreases, based on a signal of a vehicle speed sensor.

13. The massage device of claim 11, wherein the controller performs a control operation to adjust the speed of the motor to a specific RPM for a driver warning in response to a warning signal received from a lane departure warning system or a warning signal received from a collision avoidance system.

14. The massage device of claim 11, wherein the controller performs a control operation to adjust the speed of the motor to a specific RPM depending on a magnitude of body pressure in response to a body pressure detection signal received from a pressure sensor mounted on the legrest.

15. The massage device of claim 11, wherein the controller performs a control operation to drive the motor when a user turns on a switch.

16. The massage device of claim 1, wherein the striking body is disposed in a pad surrounded by a covering of the legrest.

17. The massage device of claim 6, wherein the bearing is a ball bearing.

18. A vehicle comprising the massage device of claim 1.
